(19) United States
(12) Patent Application Publication
(10) Pub. No.: US 2008/0096532 A1
(43) Pub. Date: Apr. 24, 2008

(54) EMOTIONAL STATE INTEGRATED MESSAGING

(75) Inventors: Ruthie D. Lyle, Durham, NC (US); Arthur R. Francis, Raleigh, NC (US); Morgan L. Johnson, Durham, NC (US); Veronique Moses, Raleigh, NC (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: International Business Machines Corporation, Armonk, NY (US)

(21) Appl. No.: 11/552,280

(22) Filed: Oct. 24, 2006

(51) Int. Cl. H04L 12/58; H04M 1/725

(52) U.S. Cl. 455/412.1

(57) ABSTRACT

Embodiments of the present invention address deficiencies of the art in respect to messaging and provide a method, system and computer program product for emotional state integrated messaging. In one embodiment of the invention, a method for emotional state message integration can be provided. The method can include receiving a message from a message composer and detecting meta-data associated with the message. The method further can include retrieving emotional state information from the meta-data and rendering the message. Finally, the method can include processing the emotional state information in association with the rendering of the message.

### BACKGROUND OF THE INVENTION

1. Field of the Invention

The present invention relates to the field of electronic messaging and more particularly to emotional state sensing in electronic messaging.

2. Description of the Related Art

Electronic messaging represents the single most useful task accomplished over wide-scale computer communications networks. Some argue that in the absence of electronic messaging, the Internet would have amounted to little more than a science experiment. Today, electronic messaging seems to have replaced the ubiquitous telephone and fax machine for the most routine of interpersonal communications. As such, a variety of electronic messaging systems have arisen which range from real-time instant messaging systems and wireless text pagers to asynchronous electronic mail systems.

Electronic mail, a form of electronic messaging referred to in the art as e-mail, has proven to be the most widely used computing application globally. Though e-mail has been a commercial staple for several decades, due to the explosive popularity and global connectivity of the Internet, e-mail has become the preferred mode of communications, regardless of the geographic separation of communicating parties. Today, more e-mails are processed in a single hour than phone calls. Clearly, e-mail as a mode of communications has been postured to replace all other modes of communications, save for voice telephony.

Human-to-human conversations involve more than mere content. Rather, the context of a conversational exchange oftentimes can change the ultimate meaning expressed by the content of an exchange. Messaging, particularly e-mail and instant messages, lack the context of human-to-human conversations. In as much as the remote nature of each conversant to an electronic messaging exchange cannot often “see” or “hear” each other, the mood of one conversant cannot be expressed to another in a conversation unless expressly provided by way of an indicator such as an emoticon embedded in a message.

In a human-to-human conversational exchange, the response by one conversant to the message of another conversant can vary depending upon the emotional context of the exchange. In the electronic world, however, it is not possible automate the variability of a response to a message based upon the emotional context of the message mostly because the emotional context will not be apparent from the message. Emoticons are widely used to express the emotional context of a message, though automated responses to emoticons have not been implemented. Notwithstanding, placing an emoticon in a message requires manual intervention on the part of each conversant and, as such, has not proven effective in practice. Additionally, the selection of an emoticon by a conversant need not comport with the actual emotional state of the conversant and reflects only the choice by the conversant of a corresponding emotional state.

### BRIEF SUMMARY OF THE INVENTION

Embodiments of the present invention address deficiencies of the art in respect to messaging and provide a novel and non-obvious method, system and computer program product for emotional state integrated messaging. In one embodiment of the invention, a method for emotional state message integration can be provided. The method can include receiving a message from a message composer and detecting meta-data associated with the message. The method further can include retrieving emotional state information from the meta-data and rendering the message. Finally, the method can include processing the emotional state information in association with the rendering of the message.

The method also can include acquiring an emotional state of the message composer contemporaneously while the message composer composes the message. Thereafter, the emotional state can be formatted into meta-data and the meta-data can be associated with the message. Subsequently, the message can be forwarded to a designated recipient. In one aspect of the embodiment, acquiring an emotional state of the message composer contemporaneously while the message composer composes the message can include face recognizing facial patterns of the message composer and computing an emotional state from the face recognized facial patterns. In another aspect of the embodiment, acquiring an emotional state of the message composer contemporaneously while the message composer composes the message can include voice recognizing speech patterns of the message composer and computing an emotional state from the voice recognized speech patterns.

In another embodiment of the invention, a messaging data processing system can be configured for emotional state integration. The system can include a messenger client, an emotional state sensor configured to acquire an emotional state of a message composer composing a message, and emotional state detection logic coupled to the messenger client and the emotional state sensor. The logic can include program code enabled to format an acquired emotional state into meta-data and to associate the acquired emotional state with a corresponding message prior to forwarding the message to a designated recipient.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of a emotional state integrated messaging data processing system; and,

FIG. 2 is a flow chart illustrating a process for integrating emotional state in a message system.

### DETAILED DESCRIPTION OF THE INVENTION

Embodiments of the present invention provide a method, system and computer program product for integrating emotional state in a message system. In accordance with an embodiment of the present invention, the emotional state of a conversant to an electronic conversation can be acquired. For example, the emotional state can be acquired through facial pattern recognition or voice pattern recognition. Thereafter, the emotional state can be classified in meta-data and affixed to a message from the conversant to a designated recipient of the message. Upon receipt, the meta-data can be processed to annotate the message when rendered for viewing by the designated recipient. In this way, the proper emotional context can supplement the content of the message.

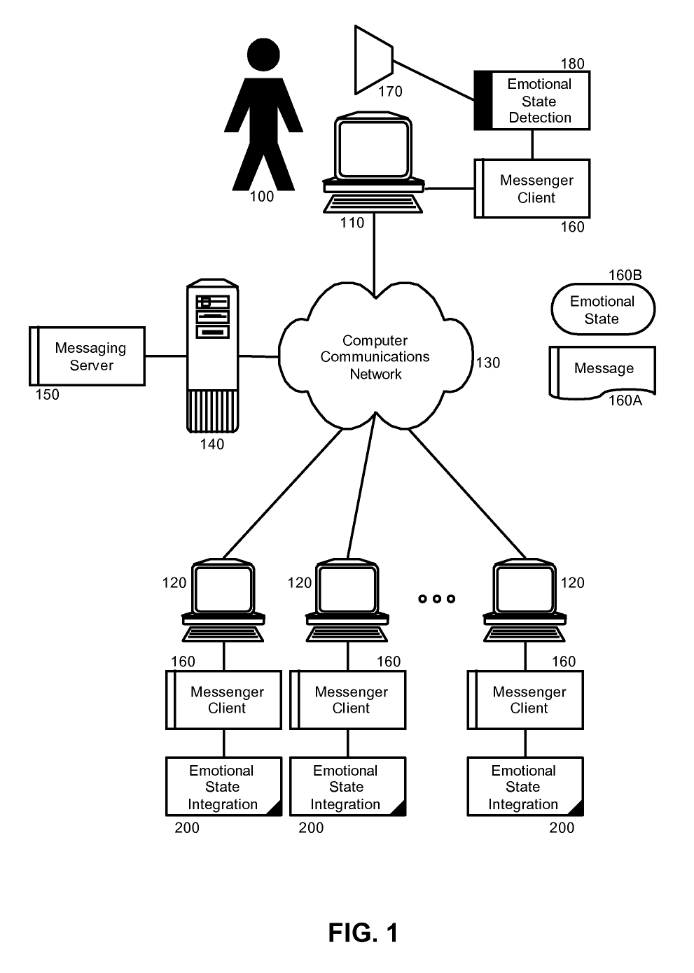

In further illustration, FIG. 1 is a schematic illustration of a emotional state integrated messaging data processing system. The system can include a server platform 140 hosting the operation of a messaging server 150, such as an e-mail server, a chat server or an instant messaging server. The server platform 140 can be coupled to multiple different client computing platforms 120, each hosting the operation of a messenger client 160, such as an e-mail client, a chat client or an instant messaging client. The multiple different client computing platforms 120 can include a particular client computing platform 110 hosting the operation of a messenger client 160 in which a message 160A can be composed by a message composer 100 for transmission to one or more designated recipients among the multiple different client computing platforms 120.

The messenger client 160 utilized by the message composer 100 further can be coupled to emotional state detection logic 180. The emotional state detection logic 180 likewise can be coupled to an emotional state sensor 170 disposed in proximity to the message composer 100. The emotional state sensor 170 can include an automated facial pattern recognizer such as that described in Chellapa P., Wilson C., and Sirohey S. Human and Machine Recognition of Faces: A Survey, in Proc. IEEE, vol. 83, no. 5, at 705-740 (1995). As another example, the emotional state sensor 170 can include an automated voice based emotional state recognizer such as that described in S. Giripunje and A. Panat, Speech Recognition for Emotions with Neural Network: A Design Approach, in Knowledge-Based Intelligent Information and Engineering Systems at 640-645 (Heidelberg 1994).

The emotional state sensor 170 can include a configuration for detecting an emotional state in the message composer 100 at the time when the message composer 100 composes the message 160. In this regard, the emotional state detection logic 180 can include program code enabled to drive the emotional state sensor 170 to acquire the emotional state of the message composer 100 and to associate the acquired emotional state with pre-configured emotional state meta-data 160B. The program code of the emotional state detection logic 180 yet further can be enabled to attach the emotional state meta data 160B to the message 160A, for example by embedding the emotional state meta-data 160B in a header of the message 160A.

Each of the messenger clients 160 in the multiple different client computing platforms 120 can be coupled to emotional state integration logic 200. The emotional state integration logic 200 can include program code enabled to detect the presence of emotional state meta-data 160B in a received message 160A. Upon detecting the presence of the emotional state meta-data 160B, the program code of the emotional state integration logic 200 can be enabled to process the emotional state meta-data 160B to supplement a view of the message 160A in the messenger client 160. For instance, an iconic indicator like an emoticon can be rendered adjacent to the message to indicate the emotional state of the message composer 100.

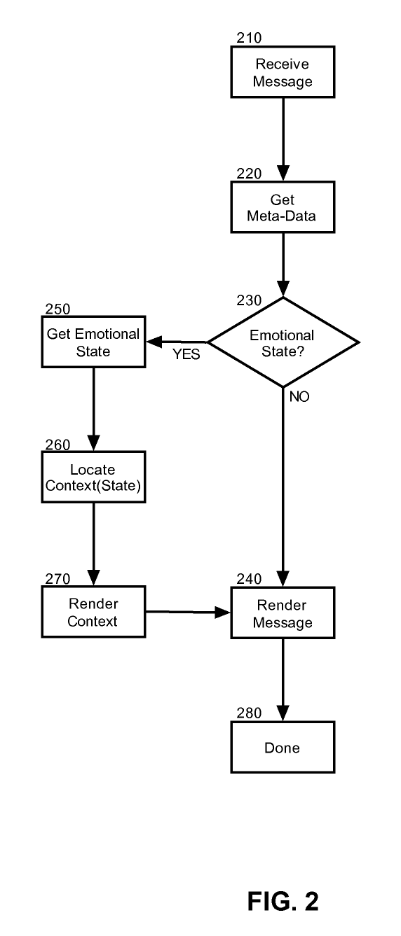

In yet further illustration, FIG. 2 is a flow chart illustrating a process for integrating emotional state in a message system. Beginning in block 210, a message can be received for processing, including an e-mail message, an instant message, or a chat message. In block 220, the meta-data associated with the message can be retrieved, for instance from the header information for the message. In decision block 230, it can be determined whether the meta-data includes emotional state information. If not, the message merely can be rendered conventionally in block 240. However, if the meta-data is determined to include emotional state information, the process can continue through block 250.

In block 250, the emotional state information can be retrieved from the meta-data and in block 260, a corresponding context can be located for the emotional state. In this regard, the emotional state can be matched with a pre-configured context such as the message composer is “happy”, “sad”, “angry”, “frustrated”, etc. Thereafter, the context can be rendered in association with the message in block 270, such as in the form of an emoticon placed in the messaging client. Concurrently, in block 240 the message itself can be rendered for the benefit of the designated recipient of the message. Finally, in block 280 the process can end.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A method for emotional state message integration, the method comprising:
receiving a message from a message composer;
detecting meta-data associated with the message;
retrieving emotional state information from the meta-data;
rendering the message; and,
processing the emotional state information in association with the rendering of the message.

2. The method of claim 1, further comprising:
acquiring an emotional state of the message composer contemporaneously while the message composer composes the message;
formatting the emotional state into meta-data;
associating the meta-data with the message; and,
forwarding the message to a designated recipient.

3. The method of claim 1, wherein processing the emotional state information in association with the rendering of the message, comprises:
locating an emoticon corresponding to the emotional state; and,
rendering the emoticon in proximity to the rendering of the message.

4. The method of claim 2, wherein acquiring an emotional state of the message composer contemporaneously while the message composer composes the message, comprises
face recognizing facial patterns of the message composer; and,
computing an emotional state from the face recognized facial patterns.

5. The method of claim 2, wherein acquiring an emotional state of the message composer contemporaneously while the message composer composes the message, comprises
voice recognizing speech patterns of the message composer; and,
computing an emotional state from the voice recognized speech patterns.

6. The method of claim 1, wherein detecting meta-data associated with the message, comprises detecting meta-data in a message header for the message.

7. The method of claim 2, wherein associating the meta-data with the message, comprises inserting the meta-data into a message header for the message.

8. A messaging data processing system configured for emotional state integration, the system comprising:
a messenger client;
an emotional state sensor configured to acquire an emotional state of a message composer composing a message;
emotional state detection logic coupled to the messenger client and the emotional state sensor, the logic comprising program code enabled to format an acquired emotional state into meta-data and to associate the acquired emotional state with a corresponding message prior to forwarding the message to a designated recipient.

9. The system of claim 8, wherein the messenger client is a client selected from the group consisting of an e-mail client, a chat client and an instant messenger client.

10. The system of claim 8, wherein the emotional state sensor comprises a sensor selected from the group consisting of a facial pattern recognizer and a voice pattern recognizer.

11. The system of claim 8, wherein the meta-data is emotional state information disposed in a message header for the message.

12. A computer program product comprising a computer usable medium having computer usable program code for emotional state message integration, the computer program product including:
computer usable program code for receiving a message from a message composer;
computer usable program code for detecting meta-data associated with the message;
computer usable program code for retrieving emotional state information from the meta-data;
computer usable program code for rendering the message; and,
computer usable program code for processing the emotional state information in association with the rendering of the message.

13. The computer program product of claim 12, further comprising:
computer usable program code for acquiring an emotional state of the message composer contemporaneously while the message composer composes the message;
computer usable program code for formatting the emotional state into meta-data;
computer usable program code for associating the meta-data with the message; and,
computer usable program code for forwarding the message to a designated recipient.

14. The computer program product of claim 12, wherein the computer usable program code for processing the emotional state information in association with the rendering of the message, comprises:
computer usable program code for locating an emoticon corresponding to the emotional state; and,
computer usable program code for rendering the emoticon in proximity to the rendering of the message.

15. The computer program product of claim 13, wherein the computer usable program code for acquiring an emotional state of the message composer contemporaneously while the message composer composes the message, comprises
computer usable program code for face recognizing facial patterns of the message composer; and,
computer usable program code for computing an emotional state from the face recognized facial patterns.

16. The computer program product of claim 13, wherein the computer usable program code for acquiring an emotional state of the message composer contemporaneously while the message composer composes the message, comprises
computer usable program code for voice recognizing speech patterns of the message composer; and,
computer usable program code for computing an emotional state from the voice recognized speech patterns.

17. The computer program product of claim 12, wherein the computer usable program code for detecting meta-data associated with the message, comprises computer usable program code for detecting meta-data in a message header for the message.

18. The computer program product of claim 13, wherein the computer usable program code for associating the meta-data with the message, comprises computer usable program code for inserting the meta-data into a message header for the message.
